(19) United States
(12) Patent Application Publication
(10) Pub. No.: US 2012/0217216 A1
(43) Pub. Date: Aug. 30, 2012

(54) Multi-Use Truck Mounted Rack System

(75) Inventors: Edward P. Owens, Reno, NV (US); Joseph P. Barrus, Reno, NV (US); David Neal Mulligan, Reno, NV (US)

(73) Assignee: STREAM LINE HOLDINGS, S.A., Panama (PA)

(21) Appl. No.: 13/034,840

(22) Filed: Feb. 25, 2011

(51) Int. Cl. B66C 13/18; B66C 19/00; B66C 15/06; B66C 13/50; B66C 15/00; B66C 13/16

(52) U.S. Cl. 212/277; 212/276

(57) ABSTRACT

A multi-use vehicle mounted loading rack system adapted to safely lift and move loads onto and off of a truck. The system includes a support which rests on bed rails which rest on a truck bed, a horizontal member, a trolley which is reversibly extendable relative to the horizontal member, a hoist mounted on the trolley, and an electrical control system including a tilt sensor and other safety features.

### BACKGROUND OF THE INVENTION

1. Technical Field of the Invention

The present invention relates in general to load management devices for lifting heavy objects into trucks. More specifically, the present invention relates to a mobile vehicle loading rack including a variety of electronics integrated therein.

2. Description of the Related Art

Load management systems are numerous and well known in the prior art. Bridge cranes are useful in loading and unloading material in warehouses and manufacturing facilities, and have been in common use for many years. Most bridge cranes are fixed to a pier and foundation system to provide structural support for the loads they manage. Mobile cranes are often of the Gantry type, e.g. having a beam down the center of two A-frames mounted on castor wheels. This allows a load to be lifted, and the crane and load moved to another location. In some cases, cranes have been mounted on flatbed trucks to provide further utility. A typical boom crane may be mobile when mounted on a truck. However, when mounted on a truck with an open top rear cargo area, such as a typical pickup truck, both boom and Gantry cranes occupy a substantial portion of the truck bed and significantly limit usage of the bed for other purposes.

Further, when cranes are adapted for use in a pickup truck, safety is an important issue. Items loaded on the back of pickup trucks are often heavy and awkward, and not uncommonly must be loaded from an incline. Thus, injury and lost productivity may be expected when a load is hoisted from uneven ground, and when the load may move unpredictably or uncontrollably. Further, when cranes are employed to assist in moving a load, the movement of the crane apparatus itself may become dangerous and the crane apparatus may strike unsuspecting workers. Vehicle position when lifting heavy loads is important in maintaining safe lifting practices. A vehicle parked on a hill facing upwards or downwards may tip; and a vehicle on a less-than-horizontal surface may roll—often with devastating consequences.

Various mobile loading racks have been devised for lifting heavy objects into trucks. These loading rack systems suffer from a variety of shortcomings including the use of complex mechanical parts which are costly, heavy, fragile, and not user friendly, the lack of safety systems to prevent over-tilt and other such dangers, and complex and difficult installation processes. For instance, U.S. Pat. No. 6,974,037 issued to Haney on Dec. 13, 2005 describes a rackmount assembly for supporting a computer enclosure in a rack system having vertical aperture column flanges. The rack-mount assembly includes an elongated mount adapter having mounting flanges at each end. Each mounting flange includes an alignment protrusion that is configured to fit in a corresponding aperture in one of the column flanges of the rack system. The elongated mount adapter comprises, for example, a slide mechanism or a rack rail. This rack-mount assembly includes complex mechanical parts that are heavy, costly and not at all user-friendly.

U.S. Pat. No. 5,850,891 issued to Olms published on Dec. 22, 1998 describes a motorized rack system for loading and unloading long items such as ladders. It includes a static rack for holding one end of a ladder and a pivoting and extendible rack. The extendible ladder rack assembly includes a base member mounted to the roof of a vehicle, an elongated pivoting member, and a slide able ladder carriage member. The system also includes a mechanism for positioning the extendible ladder rack assembly in a first locked down position of the ladder rack, a second tilted position, and a third tilted/extended position for loading and unloading a ladder. A cable is coupled to one end of the pivoting member and a cable-spooling mechanism plays out and reels in the cable for positioning the motorized ladder rack. The motorized rack system fails to provide a tilt sensor to detect when the system is beginning to tilt thereby failing to ensure safety and security.

U.S. Pat. No. 5,560,666 issued to Vieira published on Oct. 1, 1996 describes a removable rack system with the ability to carry elongated loads and is easily and simply installed and removed without the use of special tools or other equipment. The rack system includes a rear rack having a hitch tongue, which is releasable and connected to a conventional hitch receiver of the truck. A center post extends upward from the hitch tongue and supports a cross member at its upper end. The cross member may be of such a height that it can be used in conjunction with a removable front rack located near the cab of the truck. The front rack can support elongated loads that extend above the cab of the truck. However, this rack system includes complex flanges fitted with nuts and bolts resulting in difficulty of installation.

Hence there is a need for a simple, user-friendly, light weight and economical mobile loading rack system. Further, there is a need for a mobile loading rack system including a tilt sensor for added safety and security. Finally, there is a need for a mobile loading rack system which would be easily installed and could be designed to US military specifications.

### SUMMARY OF THE INVENTION

To minimize the limitations found in the prior art, and to minimize other limitations that will be apparent upon reading of the specifications, the present invention provides a vehicle mounted loading rack system. The vehicle mounted loading rack system comprises a vertical support structure, wherein a portion of the structure contacts and rests upon a vehicle, a horizontal member affixed to the vertical support structure, a trolley disposed substantially in the same plane as the horizontal member, the trolley being reversibly extendable from the horizontal member, and a hoist motor mounted on a relatively rearward portion of the trolley. The vehicle mounted loading rack system further comprises a trolley drive means for reversibly extending the trolley relative to the horizontal member, and an electrical controller adapted for monitoring and controlling the movement, usage and safety of the vehicle mounted loading rack system. The electrical controller is controlled by way of a control pendant to provide visual and audible feedback to a rack operator regarding the operating state and/or errors of the vehicle mounted loading rack system.

It is a first objective of the present invention to provide a vehicle mounted loading rack system with improved usability, versatility and flexibility.

It is a second objective of the present invention to provide a vehicle mounted loading rack system with the ability to more safely and effectively hoist a load vertically and engage a trolley to move the load horizontally into the bed of a vehicle.

It is a third objective of the present invention to provide a vehicle mounted loading rack system with an electrical controller adapted for monitoring and controlling the movement, usage and safety of the vehicle mounted loading rack system.

It is a fourth objective of the present invention to provide a vehicle mounted loading rack system with an overtilt detection means comprising a microcontroller, a tilt sensor, a real time clock circuit, and at least one external serial flash integrated circuit (IC) to ensure safe system operation and to avoid injury.

It is a fifth objective of the present invention to provide a vehicle mounted loading rack system with a control pendant to provide visual and audible feedback to a rack operator regarding the operating state and/or errors of the vehicle mounted loading rack system.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention; thus the drawings are generalized in form in the interest of clarity and conciseness.

The foregoing aspects and many of the attendant advantages of the invention will become more readily appreciated and better understood by referencing the following detailed description, when taken in conjunction with the accompanying drawings, wherein:

FIG. 1 is a perspective view of a vehicle mounted loading rack system according to a preferred embodiment of the present invention;

FIG. 2 is a perspective view of a vehicle mounted loading rack system in an extended position according to the preferred embodiment of the present invention;

FIG. 3 is a perspective view of a vehicle mounted loading rack system in a stowed position according to the preferred embodiment of the present invention;

FIG. 4 is a top view of a vehicle mounted loading rack system according to a preferred embodiment of the present invention;

FIG. 5 is a top view of a vehicle mounted loading rack system in an extended position according to the preferred embodiment of the present invention;

FIG. 6 is a top view of a vehicle mounted loading rack system in a stowed position according to the preferred embodiment of the present invention;

FIG. 7 is a bottom view of a vehicle mounted loading rack system according to the preferred embodiment of the present invention;

FIG. 8 is a rear view of a vehicle mounted loading rack system according to the preferred embodiment of the present invention;

FIG. 9 is a left side view of a vehicle mounted loading rack system according to the preferred embodiment of the present invention;

FIG. 10 is a right side view of a vehicle mounted loading rack system in an extended position according to the preferred embodiment of the present invention;

FIG. 11 is a right side view of a vehicle mounted loading rack system according to the preferred embodiment of the present invention;

FIG. 12 is a schematic of an electrical control system for monitoring and controlling the movement, usage and safety of the vehicle mounted loading rack system according to the preferred embodiment of the present invention; and

FIG. 13 is a schematic of the electrical controller illustrating a microcontroller, a tilt sensor, a real time clock circuit and at least one external serial flash integrated circuit (IC) according to the preferred embodiment of the present invention.

### DETAILED DESRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

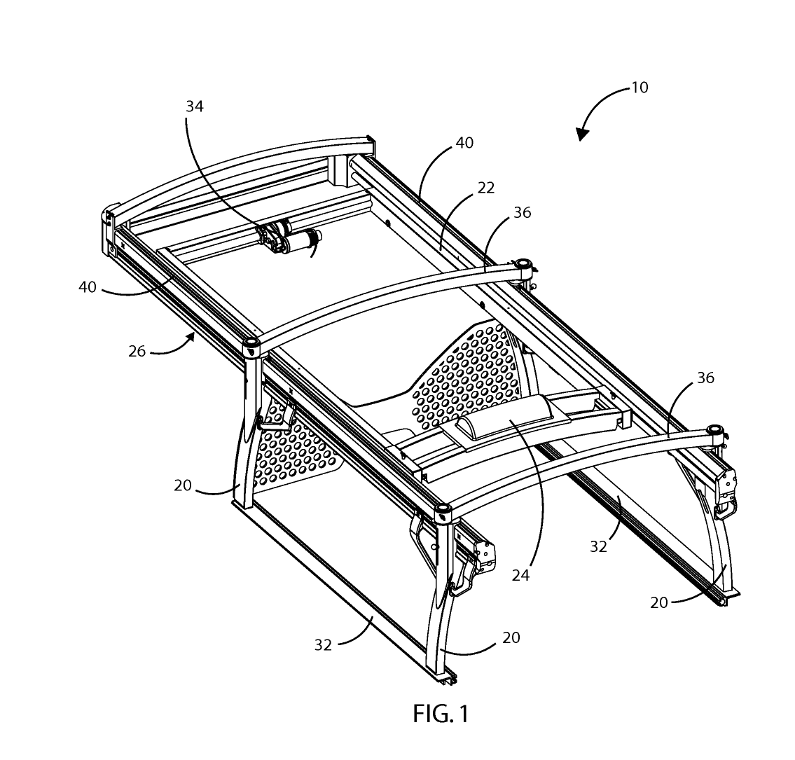

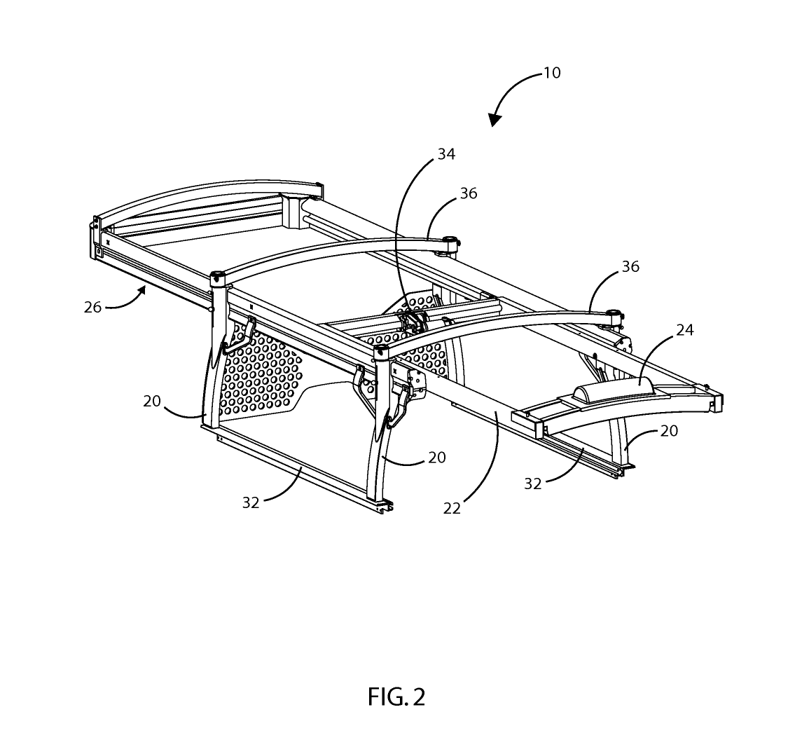

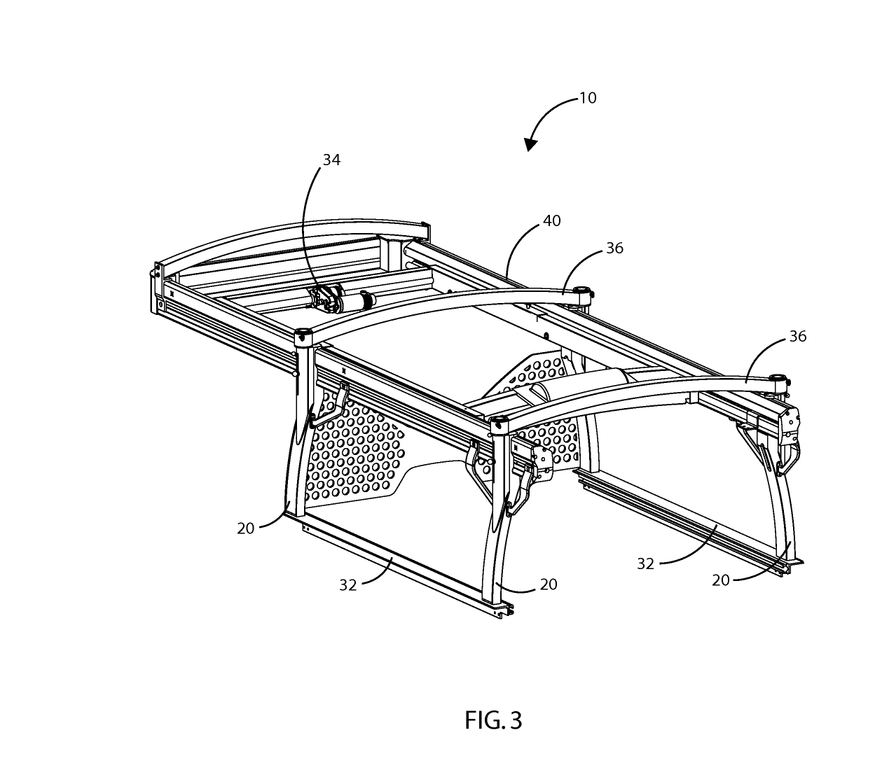

FIGS. 1, 2 and 3 show perspective views of the vehicle mounted loading rack system 10 in different positions according to a preferred embodiment of the present invention. The vehicle mounted loading rack system 10 comprises a support structure 20, wherein a portion of the structure contacts and rests upon a vehicle, a horizontal member 26 affixed to the support structure 20, a trolley 22 disposed substantially in the same plane as the horizontal member 26 and which is reversibly extendable from the horizontal member 26, and a hoist motor 24 mounted on a relatively rearward portion of the trolley 22. The portion of the support structure 20, which contacts and rests upon a vehicle may be bed rails 32. The vehicle mounted loading rack system 10 further comprises a trolley drive means for reversibly extending the trolley 22 relative to the horizontal member 26; and an electrical controller (not shown) adapted for monitoring and controlling the movement, usage and safety of the vehicle mounted loading rack system 10. The electrical controller (not shown) is controlled by way of a control pendant to provide visual and audible feedback to a rack operator regarding the operating state and/or errors of the vehicle mounted loading rack system 10. The trolley drive means is mounted on a relatively frontward portion of the trolley 22. The horizontal member 26 includes a pair of twin rails 40 affixed to a plurality of support webs. The at least one of the pair of twin rails 40 includes a drive rack bearing groove securely affixed to the surface thereof. The trolley drive means may be a rack and pinion system.

The trolley drive means may comprise: a motor 34 mounted on the trolley 22, and a driveshaft operably coupled to the motor. The motor 34 may rotatably drive the driveshaft. The trolley drive means further includes a pair of pinion wheels fixed upon either end of the driveshaft. The pinion wheels may registerably engage the twin rails 40. The rotation of the pinion wheels drives the trolley 22.

The trolley drive means may comprise a belt drive system. The motor 34 may be mounted on the trolley 22 and rotatably drive a driveshaft operably coupled to the motor, a pulley wheel fixed upon either end of the drive shaft, a first and a second belt idler affixed to the trolley 22, a belt anchored to the horizontal member 26 in a relatively forward and a relatively rearward location. The anchored belt engages the first belt idler, a portion of pulley wheel and the second belt idler and a front and a rear load wheel affixed to the trolley 22 which are freely rotatable. The pulley wheel engages the belt and the rotational motion of the pulley wheel drives the trolley 22.

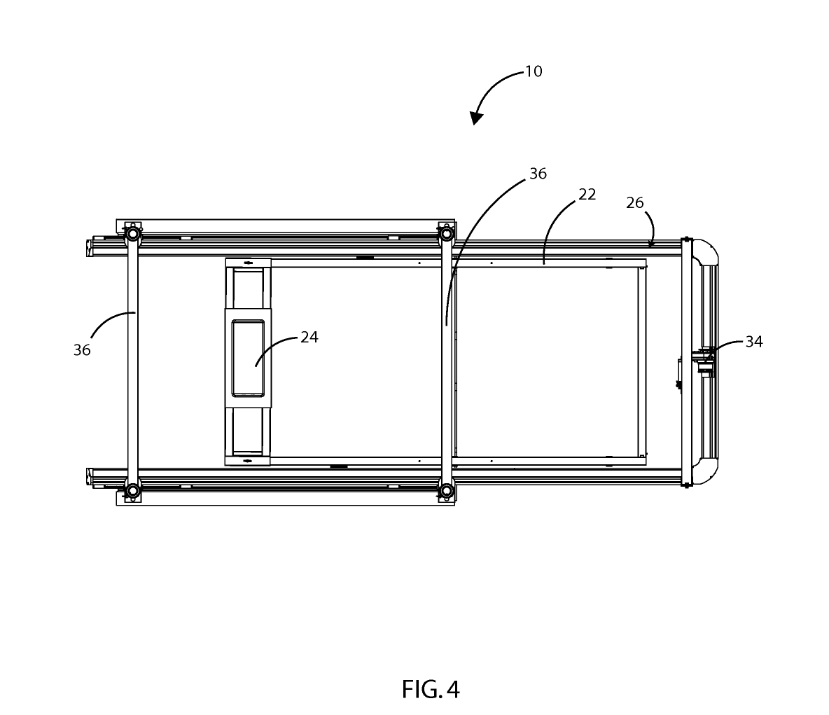

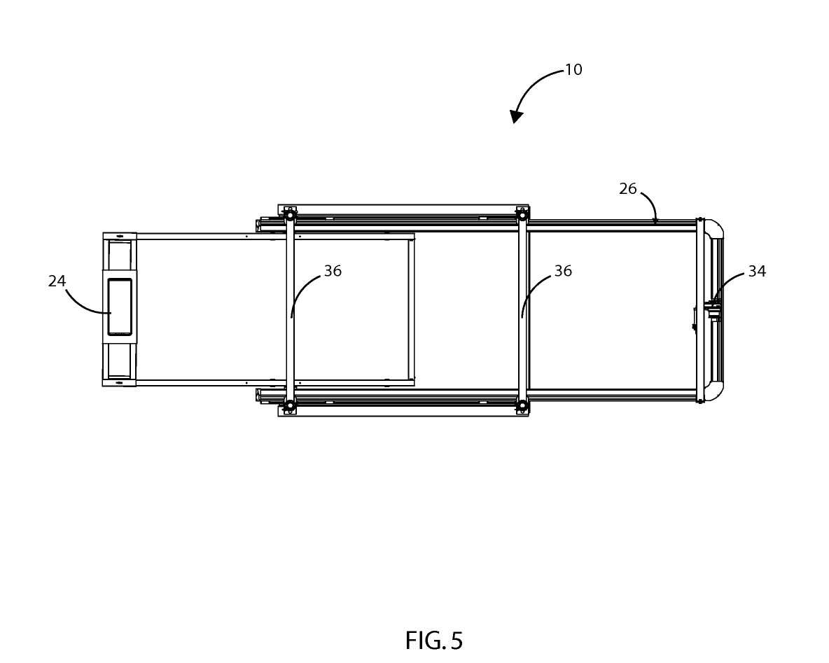

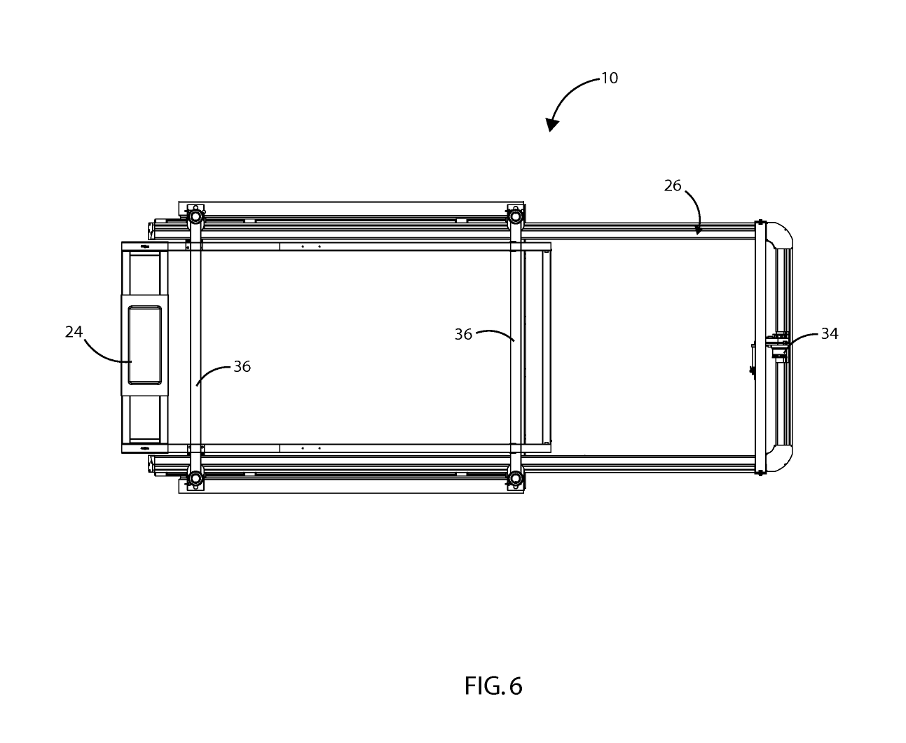

FIGS. 4, 5, 6 and 7 show top down views of a vehicle mounted loading rack system 10 in different positions according to a preferred embodiment of the present invention. The trolley drive means may be a lead screw drive means that comprises: a motor 34 mounted on the horizontal member 26 and operably coupled to a driveshaft. The motor 34 may rotatably drive the driveshaft, a first bevel gear upon either end of the driveshaft, a second bevel oriented at 90 degrees relative to and registering with the first bevel gear, and a lead screw having a first end and second end, the first end of said lead screw affixed to the second bevel gear. The trolley 22 may have a cylindrical guide affixed thereto, the guide having an inner threading. The lead screw and the first and second bevel gear rotate with the rotation of the driveshaft and drive the trolley 22 longitudinally via said threaded cylindrical guide. The vehicle mounted loading rack system 10 further comprises at least two cross bars 36 affixed to the support structure 20. The crossbars may be arcuately shaped.

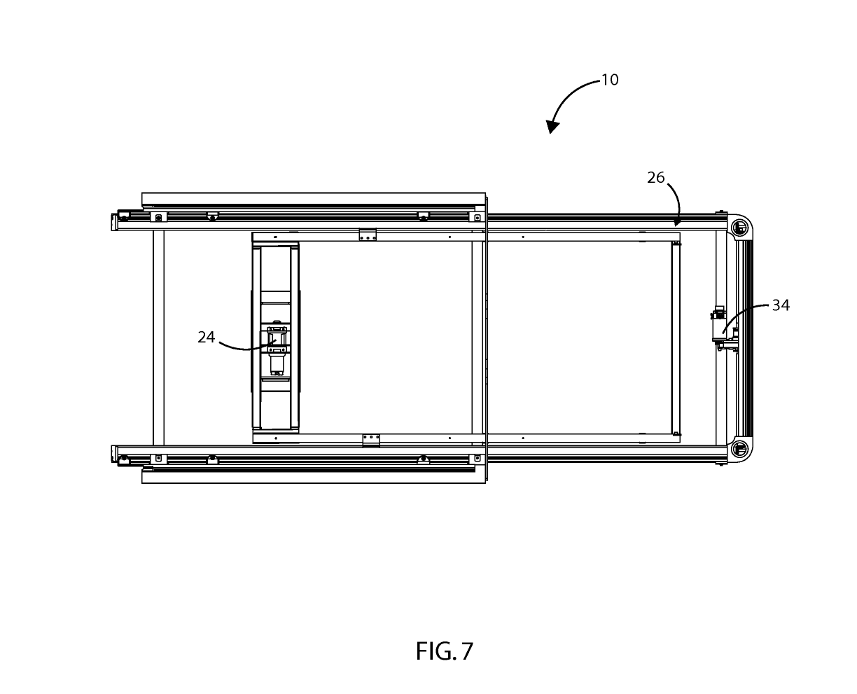

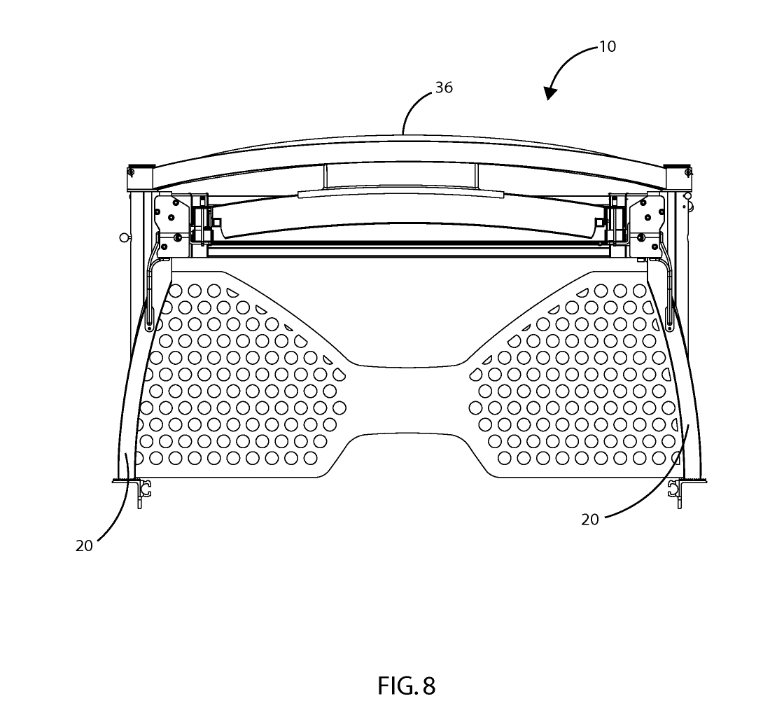

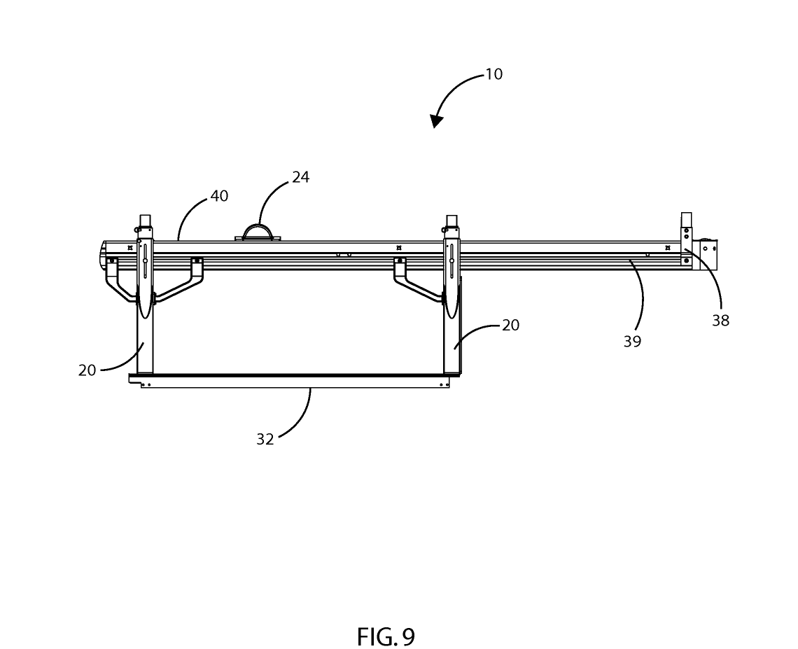

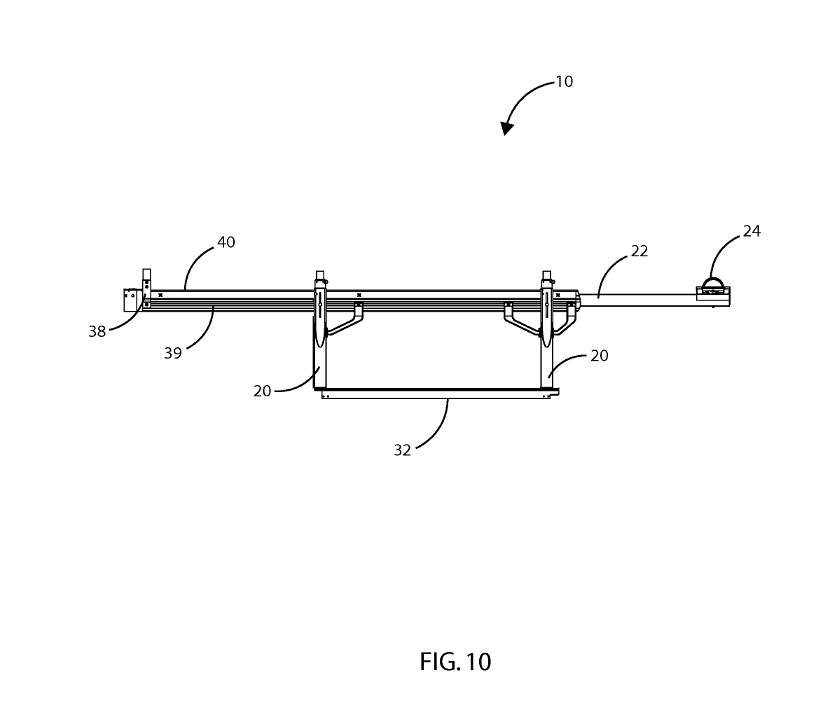

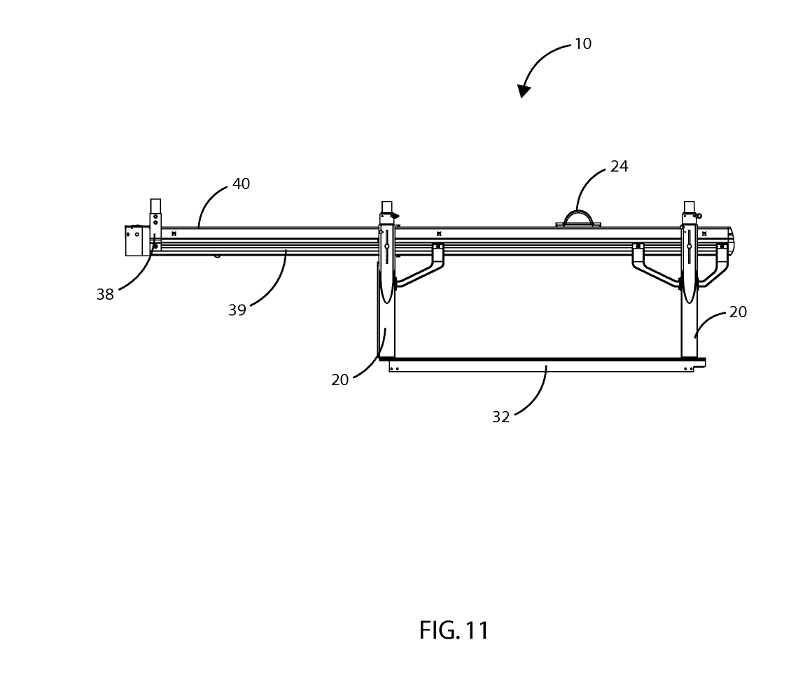

FIGS. 8, 9, 10 and 11 show a rear view, a right side view, a left side view, and a left side view respectively of a vehicle mounted loading rack system 10 in different positions according to the preferred embodiment of the present invention. The horizontal member 26 (labeled in FIG. 7) has a front support 38 and sides 39. The sides 39 are formed of extruded aluminum wherein a portion may be shaped to define a wheel guide, a may be shaped portion is shaped to define a lead screw recess, a T-slot accessory recess, and a plurality of attachment points.

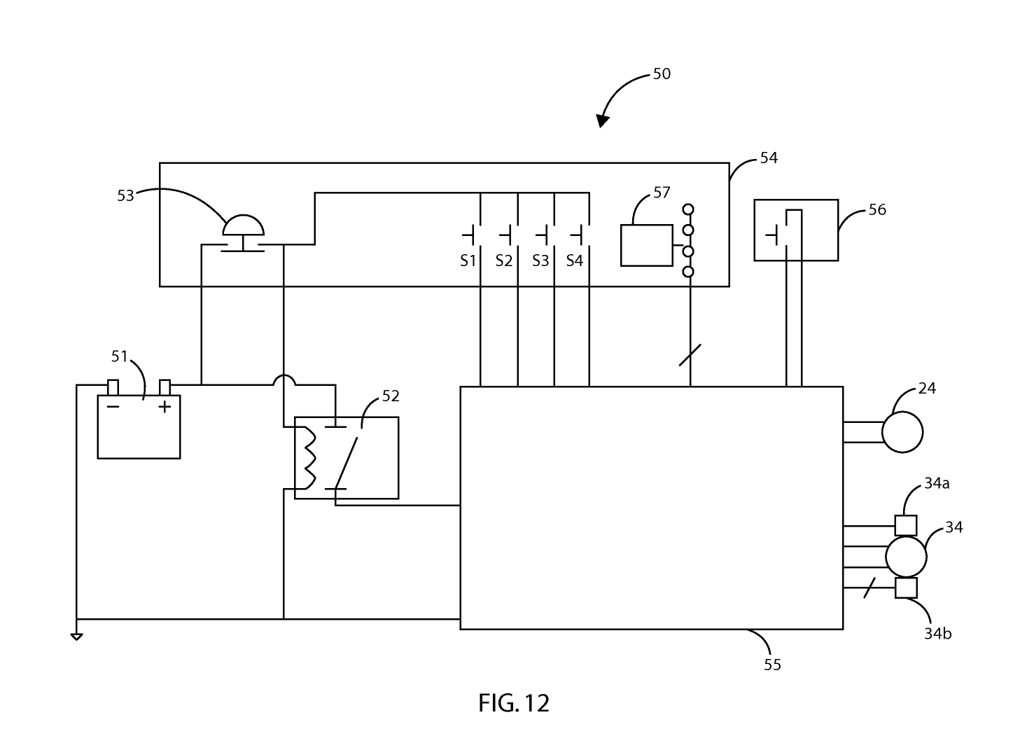

FIG. 12 shows a schematic of an electrical control system 50 for monitoring and controlling the movement, usage and safety of the vehicle mounted loading rack system 10 according to a preferred embodiment of the present invention. A vehicle battery 51 is connected to a power disconnect switch 52. In a preferred embodiment of the present invention the power disconnect switch 52 is a Cole Hersee 24059-08 solenoid. The power disconnect switch 52 is controlled by an emergency stop button 53. In a preferred embodiment of the present invention the emergency stop button 53 is located in a control pendant 54 held by the operator. When the emergency stop button 53 is activated all power to an electrical controller 55 and motors is disconnected. Also shown is an electrical controller 55 electrically connected to a hoist motor 24 a trolley motor 34, a trolley motor brake 34a, a trolley motor shaft encoder 34b, a control pendant 54 and a switch 56.

As shown in FIG. 12 the control pendant 54 includes a plurality of input switches and a plurality of output light emitting diode (LED) indicators and an audible sound output device 57 according to a preferred embodiment of the present invention. The control pendant 54 is electrically connected to the electrical controller 55. In a preferred embodiment of the present invention the control pendant 54 comprises four directional buttons, S1, S2, S3, and S4 and an emergency stop button 53. In an alternate embodiment the control pendant 54 has a four directional button or an equivalent directional interface. In an alternate embodiment the control pendant 54 is directly coupled to the hoist and trolley motor control switches. In a preferred embodiment of the present invention the control pendant 54 includes an audible sound output device 57 to signal the operator of certain conditions. The audible sound device is electrically connected to the microcontroller (not shown).

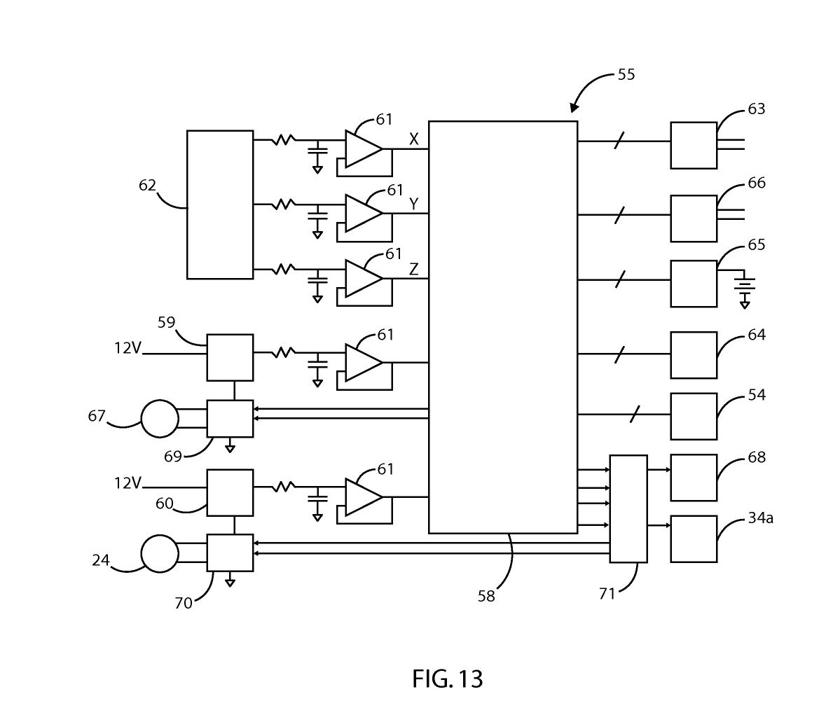

FIG. 13 shows an electrical controller 55 comprising a microcontroller 58. In a preferred embodiment of the present invention the microcontroller 58 is a Freescale MS90S08DZ32. The electrical controller 55 also comprises a plurality of overcurrent detection means for protecting the rack system 10 from loads larger than rated values and it also protects the hoist motor 24, the trolley motor 34, and power control circuitry from high currents. The overcurrent detection means comprises: a first Hall-effect integrated circuit 59 electrically connected to the hoist motor 24 and a second Hall-effect integrated circuit 60 electrically connected the trolley motor 34, and an operational amplifier 61 electrically connected to each Hall-effect sensor output and a microcontroller 58 electrically coupled to the operational amplifiers 61. The operational amplifier 61 conditions the Hall-effect integrated circuit outputs and connects to one of a plurality of microcontroller analog to digital converter inputs. The microcontroller 58 can sense a voltage proportional to the current in a motor and is programmed with a predetermined threshold value, if the current reaches the predetermined value, current flowing to that motor is disconnected or stopped. In a preferred embodiment of the present invention the first Hall-effect integrated circuit 59 is an Allegro ACS715 and the second Hall-effect integrated circuit 60 is a Melexis MLX91206.

As shown in FIG. 13 the electrical controller 55 further comprises an overtilt detection means to ensure safe apparatus operation. The overtilt detection means comprises a tilt sensor 62. In a preferred embodiment of the present invention the tilt sensor 62 comprises a Freescale MMA7361 3-axis accelerometer. The 3-axis accelerometer contains X, Y, and Z-axis voltage outputs. The X and Y-axis are used for monitoring and Z-axis is used for confirmation. Each accelerometer voltage output is electrically coupled to an operational amplifier 61. The operational amplifier 61 conditions the accelerometer outputs and connects to one of a plurality of microcontroller analog to digital converter inputs. The accelerometer outputs can be read by the microcontroller 58 and the tilt calculated by the microcontroller 58, the microcontroller 58 being programmed with a predetermined tilt threshold value, if the value is reached, operation of the rack system 10 is disabled and the user is notified by a visual LED indicator in the control pendant 54 and the audible indicator (not shown).

The electrical controller 55 further comprises a real time clock 65 that may be powered by a coin cell lithium battery. In a preferred embodiment of the present invention the real time clock 65 comprises a Philips PCA8565. The voltage of the lithium battery may be electrically connected to a one of a plurality of microcontroller analog to digital converter inputs, the microcontroller 58 may be programmed to monitor and log the lithium battery voltage. In a preferred embodiment of the present invention the vehicle battery voltage is electrically connected to a one of a plurality of microcontroller analog to digital converter inputs the microcontroller 58 being programmed with a predetermined vehicle battery voltage threshold value, if the value is lower, a indicator light in the control pendant 54 is activated to warn the operator, if the value is lower than a second lower threshold then operation of the rack system 10 is disabled to prevent over discharge of the vehicle battery 51.

The electrical controller 55 further comprises at least one external serial flash integrated circuit (IC) 64. In a preferred embodiment of the present invention the serial flash integrated circuit (IC) 64 comprises a Silicon Storage Technology SST25VF016B. The at least one external serial flash integrated circuit (IC) 64 may be adapted for storing the datalogs of the vehicle mounted loading rack system 10. The electrical controller 55 further comprises at least one controller area network (CAN) interface integrated circuit 63 that is designed to translate incoming and outgoing controller area network (CAN) protocol data to the microcontroller 58. In a preferred embodiment of the present invention controller area network (CAN) interface integrated circuit 63 comprises a Texas Instruments SN65HVD230.

The electrical controller 55 may include a serial computer interface 66. This interface 66 may be used to download datalogs, for initial factory calibration and testing, for factory service, for diagnostics, and the like. The serial interface 66 may be easily adapted to connect to a computer with a USB port. This serial interface 66 may also be used to communicate to the controller via a radio frequency (RF) interface. This RF interface may be Bluetooth, Zigbee, 900 MHz or other radio frequency interface. The vehicle mounted loading rack system 10 further comprises at least one gross vehicle weight (GVW) sensor for determining the load that may be safely placed on the vehicle.

The vehicle mounted loading rack system 10 further comprises a trolley location control means 34b for controlling the position of the trolley (not shown). In a preferred embodiment of the present invention the trolley location control means 34b is comprised of at least one shaft encoder. The output of the trolley location control means 34b is electrically connected to the microcontroller 58. The microcontroller 58 can interpret the output of the trolley (not shown) and calculate the position of the trolley (not shown) and thereby protect the trolley (not shown) from traveling too far in either direction, if the position reaches the predetermined limits, current flowing to the trolley motor 34 is disconnected or stopped.

The vehicle mounted loading rack system 10 may further comprise a safety sensing means. The safety sensing means comprises: a pressure actuated tape switch 56 mounted on the outer aspect of the trolley (not shown) and electrically connected to the electrical controller 55, wherein if the tape switch is actuated, current flowing through the trolley drive means is disconnected or stopped.

The electrical controller 55 further comprises at least one alarm circuit 68 that is designed to generate an audible alarm when the trolley (not shown) moves. The electrical controller 55 further comprises a plurality of input switches. The plurality of input switches includes a plurality of tape switch inputs 56 and a plurality of limit switches. The limit switches disable either forward or reverse movement of the trolley (not shown) preventing mechanical and or electrical damage by the trolley traveling too far in either direction.

As shown in FIG. 13 the electrical controller 55 further comprises at least one trolley power control circuit 69, which is utilized for controlling the trolley motor 34. In a preferred embodiment of the present invention the trolley power control circuit 69 consists of an H-bridge motor driver, such as the ST Microelectronics VNH3SP30-E. Using an H-bridge motor driver allows the microcontroller 58 to control the speed of the trolley motor 34 by pulse width modulating the motor control signal. In an alternate embodiment the trolley power control circuit 69 consists of a pair of relays or a reversing contactor. As shown the electrical controller 55 comprises at least one hoist power control circuit 70 which is utilized for controlling the hoist motor 24. In a preferred embodiment of the present invention the hoist power control circuit 70 consists of a high current reversing contactor. In a preferred embodiment of the present invention the control signals to the hoist power control signals are connected to the microcontroller 58 via a high-side power switch 71, in this exemplary embodiment an Infineon BTS716 GB. The high-side power switch 71 electrically connects to the microcontroller 58 and provides higher current outputs than the microcontroller 58 can normally provide. The high-side power switch 71 also electrically connects the microcontroller 58 to the alarm 68 and the trolley motor brake 34a.

The electrical controller 55 further comprises at least one input signal conditioning circuitry adapted to provide the voltage required by the microcontroller 58 and to protect the controller from high voltage transients. The electrical controller 55 further comprises at least one input signal conditioning circuitry adapted to protect microcontroller input/output connections to reduce noise and switch bounce, and to protect the microcontroller 58 from high voltage transients.

A load can be safely loaded utilizing a vehicle mounted loading rack system 10 having a support structure 20 in the following manner: Initially the load to be loaded is identified. A vehicle mounted loading rack system 10 having a support structure 20 is provided. A portion of the support structure 20 makes contact with and rests upon a vehicle. A horizontal member 26 affixed to the support structure 20 is provided. A trolley 22 disposed substantially in the same plane as the horizontal member 26 reversibly extendable from the horizontal member 26 is provided. The hoist motor 24 mounted on a relatively rearward portion of the trolley 22 is provided. A trolley drive means for reversibly extending the trolley 22 relative to the horizontal member 26 is provided. An electrical controller with a control pendant adapted for monitoring and controlling the movement, usage and safety of the vehicle mounted loading rack system 10 is provided. A DC motor controlling means provides forward and reverse trolley movement, and up and down movement of the hoist motor 24 and an emergency stop. The trolley 22 is extended from the vehicle mounted loading rack system 10 and the load is attached. Then the hoist motor 24 is actuated. The hoist motor 24 is sufficient to raise the load above the level of the truck where the load is to be positioned. The trolley motor 34 is actuated in a frontward direction. The trolley 22 with hoisted load is moved horizontally toward the front of the truck. The trolley motor 34 is stopped when a desired horizontal position is reached. Finally, the hoist motor 24 is actuated to lower the load into the desired position.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given or particular application.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

We claim:

1. A vehicle mounted loading rack system comprising:
a support structure, wherein a portion of the structures contacts and rests upon a vehicle;
a horizontal member affixed to the support structure;
a trolley disposed substantially in the same plane as the horizontal member, reversibly extendable from the horizontal member;
a hoist motor mounted on a relatively rearward portion of the trolley;
a trolley drive means for reversibly extending the trolley relative to the horizontal member;
an electrical controller adapted for monitoring and controlling the movement, usage and safety of the vehicle mounted loading rack system; and
wherein the hoist motor may be actuated to lift a load vertically, wherein the trolley drive means, when actuated, may move the lifted load horizontally relative to the vehicle, wherein the load may be lowered onto the vehicle or onto a surface outside the vehicle.

2. The vehicle mounted loading rack system of claim 1 wherein the trolley drive means is a rack and pinion system that comprises: a motor mounted on the trolley; a driveshaft operably coupled to the motor, wherein the motor may rotatably drive the driveshaft; a pair of pinion wheels fixed upon either end of the driveshaft, wherein the pinion wheels may registerably engage the rack, and wherein rotation of the pinion wheels drives the trolley.

3. The vehicle mounted loading rack system of claim 1 wherein the trolley drive means is a belt drive system that comprises: a motor mounted on the trolley; a driveshaft operably coupled to the motor, wherein the motor may rotatably drive the driveshaft; a pulley wheel fixed upon either end of the driveshaft; a first and a second belt idler affixed to the trolley; an anchored belt affixed to the horizontal member in a relatively forward and a relatively rearward location, wherein the anchored belt engages the first belt idler, a portion of the pulley wheel and the second belt idler; and a front and a rear load wheel affixed to the trolley and freely rotatable thereupon; whereby the pulley wheel engages the belt and the rotational motion of the pulley wheel drives the trolley.

4. The vehicle mounted loading rack system of claim 1 wherein the trolley drive means is a lead screw drive means that comprises: a motor mounted on the horizontal member; a driveshaft operably coupled to the motor, wherein the motor may rotatably drive the driveshaft; a first bevel gear upon either end of the driveshaft; a second bevel oriented at 90 degrees relative to and registering with the first bevel gear; a lead screw having a first end and second end, the first end of the lead screw affixed to the second bevel gear; a cylindrical guide affixed to the trolley, the guide having an inner threading, whereby the lead screw and the first and second bevel gears rotate with the rotation of driveshaft when the trolley is driven longitudinally.

5. The vehicle mounted loading rack system of claim 1 wherein the electrical controller further comprises a microcontroller having a plurality of analog to digital converter input pins, the microcontroller operatively coupled via said input pins to a first and second Hall-effect integrated circuit having an output electrically connected to said hoist motor and said trolley drive means respectively, wherein the output current may be sensed by the microcontroller and compared to a threshold value.

6. The vehicle mounted loading rack system of claim 1 wherein the electrical controller further comprises a tilt sensor, wherein the tilt sensor comprises a three-axis accelerometer.

7. The vehicle mounted loading rack system of claim 1 wherein the electrical controller further comprises at least one external serial flash integrated circuit (IC); adapted for storing the datalogs of the vehicle mounted loading rack system.

8. The vehicle mounted loading rack system of claim 1 wherein the electrical controller further comprises at least one controller area network (CAN) interface adapted to translate incoming and outgoing controller area network (CAN) protocol data to the microcontroller.

9. The vehicle mounted loading rack system of claim 1 wherein the electrical controller further comprises a plurality of overcurrent detection means for protecting the hoist motor and the trolley drive means from high currents and protecting the vehicle mounted loading rack system from lifting or moving a load greater than a specified limit.

10. The vehicle mounted loading rack system of claim 9 wherein the over current detection means comprises: a Hall-effect integrated circuit electrically connected to the hoist motor and the trolley drive means, sensing current flowing through the hoist motor; an operational amplifier electrically connected to the Hall-effect current sense integrated circuit, wherein the operational amplifier conditions the Hall-effect current sense integrated circuit output signals; a microcontroller electrically coupled to the operational amplifier includes a plurality of analog to digital converter input pins, wherein the microcontroller senses current and is programmed with a predetermined threshold value, wherein if the value is reached, current flowing to the motor is disconnected or stopped.

11. The vehicle mounted loading rack system of claim 1 wherein the electrical controller further comprises at least one input signal conditioning circuitry adapted to provide the voltage required by the microcontroller, to reduce noise and switch bounce, and to protect the controller from high voltage transients.

12. The vehicle mounted loading rack system of claim 1 wherein the electrical controller further comprises at least one alarm detection circuit with an audible sound output device configured to generate an audible alarm when the trolley moves.

13. The vehicle mounted loading rack system of claim 1 wherein the electrical controller further comprises a control pendant electrically coupled to the motor control switches, wherein the control pendant has four directional buttons and an emergency stop button.

14. The vehicle mounted loading rack system of claim 1 further comprising at least one gross vehicle weight (GVW) sensor for determining the load that may be safely placed on the vehicle.

15. The vehicle mounted loading rack system of claim 1 further comprises a trolley location control means for controlling the position of the trolley.

16. The vehicle mounted loading rack system of claim 15 wherein the trolley location control means comprises at least one shaft encoder.

17. The vehicle mounted loading rack system of claim 1 further comprises an overtilt detection means to provide safe system operation.

18. The vehicle mounted loading rack system of claim 17 wherein said overtilt detection means comprises a tilt sensor, wherein the tilt sensor comprises a three-axis accelerometer, wherein the output is electrically coupled to one of a plurality of microcontroller analog to digital converter inputs.

19. The vehicle mounted loading rack system of claim 18 wherein said three-axis accelerometer comprises an X-axis, a Y-axis, and a Z-axis; and wherein said X-axis and said Y-axis are used for monitoring and said Z-axis is used for confirmation.

20. The vehicle mounted loading rack system of claim 17 wherein the overtilt detection means comprises: an accelerometer electrically connected to an operational amplifier, wherein the operational amplifier provides signal conditioning; a microcontroller having at least one analog to digital converting input, wherein the output from the operational amplifier is electrically connected to the analog-to-digital converting input pin, wherein a voltage proportional to the tilt may be sensed by the microcontroller, the microcontroller being programmed with a predetermined threshold value, wherein if the value is reached, current flowing to the motor is disconnected or stopped.

21. The vehicle mounted loading rack system of claim 1 further comprising a safety sensing means to avoid injury, the safety sensing means comprising a pressure actuated tape switch mounted on the outer aspect of the trolley and electrically connected to the trolley drive means, wherein if the tape switch is actuated, current flowing through the trolley drive means is disconnected or stopped.

22. The vehicle mounted loading rack system of claim 1 further comprising a direct current (DC) motor controlling means configured to provide forward and reverse trolley movements, up and down movement of the hoist motor, and an emergency stop, the means comprising: a plurality of switches permitting bi-directional hoist motor actuation, at least one emergency switch, wherein the emergency switch is normally closed, and wherein actuation of the switch will stop or disable all motor movement.

23. A vehicle mounted loading rack system comprising:
a support structure having bed rails affixed to vertical support members, wherein the bedrail is in contact with the sides of a truck bed, and wherein the vertical support members extend relatively vertical from the bed rails;
a horizontal member having sides and a font defining corners; wherein the sides of the horizontal member are affixed to the vertical supports, wherein the sides are shaped to define a wheel guide;
a trolley having a front end and rear end, an end truck attached to the rear end, a pair of wheels mounted on the trolley and freely rotatable thereupon, wherein the wheels engage the wheel guide of the horizontal member;
a hoist motor mounted on the end truck;
a trolley motor mounted on a relatively front portion of the horizontal member;
a drive shaft operatively coupled to the trolley motor, wherein the drive shaft is rotatably driven by the motor;
a microcontroller having a plurality of analog to digital converter input pins, the microcontroller operatively coupled to a first and second Hall-effect integrated circuit electrically coupled to the hoist motor and the trolley motor respectively and electrically connected to an analog-to-digital pin, wherein a current flowing through the hoist motor sensed by the microcontroller and compared to a threshold value;
a tilt sensor, wherein the tilt sensor comprises a three axis accelerometer, wherein the output is electrically coupled to one of the plurality of microcontroller analog to digital converter input pins;
a real time clock;
at least one controller area network (CAN) sensor designed to translate incoming and outgoing controller area network (CAN) protocol data to the microcontroller;
a plurality of overcurrent detection means for protecting the hoist motor and the trolley motor from high current and protecting the rack system from lifting or moving a load greater than a specified limit;
at least one input signal conditioning circuitry adapted to provide the voltage needed to the microcontroller, to reduce noise and switch bounce, and to protect the controller from high voltage transients;
at least one trolley power control circuitry utilized for controlling the trolley motor;
at least one alarm detection circuit designed for generating an audible alarm when the trolley moves;
a control pendant electrically coupled to the motor control switches, wherein the pendant has four directional buttons and an emergency stop button.

24. The vehicle mounted rack system of claim 23 wherein the control pendant includes a plurality of light emitting diode (LED) indicators to provide visual feedback to a rack operator regarding the operating state and/or errors of the vehicle mounted loading rack system.

25. The vehicle mounted rack system of claim 23 wherein further comprising at least one external serial flash integrated circuit (IC) adapted for storing the datalogs of the vehicle mounted loading rack system.

26. A method of safely loading a load by utilizing a vehicle mounted loading rack system, the method comprising the steps of:
identifying a load to be moved;
providing a vehicle mounted rack system having a support structure, wherein a portion of the support structure makes contact and rests upon a vehicle;
providing a horizontal member affixed to the support structure;
providing a trolley disposed substantially in the same plane as the horizontal member, reversibly extendable from the horizontal member;
providing a hoist motor mounted on a relatively rearward portion of the trolley;
providing a trolley drive means for reversibly extending the trolley relative to the horizontal member;
providing an electrical controller with a control pendant adapted for monitoring and controlling the movement, usage and safety of the vehicle mounted loading rack system;
providing a DC motor controlling means to provide forward and reverse trolley movement, and up and down movement of the hoist motor and an emergency stop;
attaching the load to the vehicle mounted loading rack system;
actuating the hoist motor to raise the load above the level of the truck where the load is to be positioned;
actuating the trolley motor in a frontward direction, wherein the trolley with hoisted load is moved horizontally toward the front of the truck;
stopping the trolley motor when a desired horizontal position is reached; and
actuating the hoist motor to lower the vehicle mounted loading rack system into the desired position.

27. The method of claim 26 wherein the vehicle mounted loading rack system comprises at least one gross vehicle weight (GVW) sensor for determining the load that may be safely placed on the vehicle.

28. The method of claim 26 further comprising the steps of providing a tilt sensor, wherein the tilt sensor comprises a three axis accelerometer, wherein the output is electrically coupled to the electronic control system, and wherein if the output exceeds a threshold value the electronic control system will stop all motion of said hoist motor and said trolley drive means.
